(19) United States
(12) Patent Application Publication
(10) Pub. No.: US 2019/0213470 A1
(43) Pub. Date: Jul. 11, 2019

(54) ZERO INJECTION FOR DISTRIBUTED DEEP LEARNING

(71) Applicant: NEC Laboratories Europe GmbH, Heidelberg (DE)

(72) Inventor: Mischa Schmidt, Heidelberg (DE)

(21) Appl. No.: 15/865,294

(22) Filed: Jan. 9, 2018

(51) Int. Cl. G06N 3/04; G06N 3/063; H04L 29/08; G06F 17/16

(52) U.S. Cl. CPC G06N 3/0454; G06F 17/16; H04L 67/104; G06N 3/063

(57) ABSTRACT

A method for compressing distributed deep learning gradient traffic in data parallel settings includes removing gradients of dropped neurons from gradient updates to obtain a compressed gradient update. Dropped neuron information and the compressed gradient update are transmitted to one or more receivers. Correct gradient updates are recovered by zero injection into the compressed gradient update based on the dropped neuron information.

### FIELD

The present invention relates to compressing distributed deep learning gradient traffic.

### BACKGROUND

Deep learning, deep structured learning, or deep machine learning is based on a set of algorithms that attempt to model high-level abstractions in data by using multiple processing layers, with complex structures or otherwise, composed of multiple non-linear transformations. Deep learning involves learning data representations and can be applied across different fields including speech recognition, natural language processing, audio recognition, social network filtering, machine translation, and so on.

Deep learning is a class of machine learning approaches that has achieved notable success across a wide spectrum of tasks, including speech recognition, visual recognition and language understanding. These deep learning models exhibit a high degree of model complexity, with many parameters in deeply layered structures that usually take days to weeks to train on a graphics processing unit (GPU)-equipped machine. The high computational cost of deep learning programs on large-scale data necessitates the training on distributed GPU cluster in order to keep training time acceptable.

Most neural networks (NNs) need to be trained with data to give accurate predictions. Stochastic gradient descent (SGD) and backpropagation are commonly employed to train NNs iteratively—each iteration performs a feed forward (FF) pass followed with a backpropagation (BP) pass. In the FF pass, the network takes a training sample as input, forwards from its input layer to output layer to produce a prediction. A loss function is defined to evaluate the prediction error, which is then backpropagated through the network in reverse, during which network parameters are updated by their gradients towards where the error would decrease. After repeating a sufficient number of passes, the network will usually converge to some state where the loss function evaluates to a minima, and the training is then terminated.

### SUMMARY

In an embodiment, the present invention provides a method for compressing distributed deep learning gradient traffic in data parallel settings. The method includes removing gradients of dropped neurons from gradient updates to obtain a compressed gradient update. Dropped neuron information and the compressed gradient update are transmitted to one or more receivers. Correct gradient updates are recovered by zero injection into the compressed gradient update based on the dropped neuron information.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates data parallelism models in a parameter server setting vs a P2P setting according to an embodiment of the invention;

FIG. 2 illustrates an idealized deep learning node according to an embodiment of the invention;

FIG. 3 illustrates a zero injection deep learning node architecture according to an embodiment of the invention;

FIG. 4 illustrates a parameter server supporting zero injection according to an embodiment of the invention;

FIG. 5 illustrates another parameter server supporting zero injection according to an embodiment of the invention; and

FIG. 6 is a flowchart for compressing distributed deep learning gradient traffic in data parallel settings according to an embodiment of the invention.

### DETAILED DESCRIPTION

In training NNs on distributed GPU cluster, high computational throughput of GPUs allows more data batches to be processed per minute (than CPUs), leading to more frequent network synchronization that grows with the number of machines. Existing communication strategies, such as parameter servers for machine learning, can be overwhelmed by the high volume of communication. Moreover, despite the increasing availability of faster network interfaces such as Infiniband or 40 GbE Ethernet, GPUs have continued to grow rapidly in computational power, and continued to produce parameter updates faster than can be naively synchronized over the network. For instance, on a 16-machine cluster with 40 GbE Ethernet and one Nvidia Titan X GPU per machine, updates from the VGG19-22K neural network model will bottleneck the network, so that only an 8× speedup over a single machine is achieved. H. Zhang et al., “Poseidon: An Efficient Communication Architecture for Distributed Deep Learning on GPU Clusters,” USENIX ATC (2017), which is incorporated by reference in its entirety, discusses GPU implementation of VGG19-22K network for image classification.

The inventor recognized that these scalability limitations in distributed deep learning stem from at least two causes: (1) the gradient updates to be communicated are very large matrices, which quickly saturate network bandwidth; (2) the iterative nature of deep learning algorithms causes the updates to be transmitted in bursts (at the end of an iteration or batch of data), with significant periods of low network usage in-between. In an embodiment, the invention provides a solution to these two problems by exploiting the structure of deep learning algorithms on two levels: firstly, it identifies ways in which the matrix updates can be separated from each other, and secondly, it schedules the matrix updates in a way that avoids bursty network traffic.

The scalability limitations in distributed deep learning relying on GPU computing resources stem from gradient updates being very large matrices, which require transmission time and may even quickly saturate network bandwidth; and the bursty communication pattern caused by the iterative nature of deep learning algorithms. The transmission associated to exchanging gradient or weight matrices for deep learning can cause the computing resources to idle, i.e., CPUs and GPU resources spend an excessive amount of time waiting for communication to complete. In this manner, computing resources are not used in an efficiently and the time to train deep neural networks is therefore increased.

Embodiments of the invention compress gradient updates for deep learning models using the dropout heuristic in the data parallel setting. This helps computing clusters (e.g. with GPU resources) by saving communication bandwidth. The compression bases on the fact that in common parameter synchronization approaches for distributed deep learning, 0 values (corresponding to neurons dropped due to dropout) are nevertheless communicated. The embodiments of the invention reduce bandwidth by exploiting the matrix structures inherent to neural network learning, thus leveraging information from dropout training to remove unnecessary data transmission without loss of accuracy or information.

Embodiments of the invention provide several improvements in distributed neural network training by reducing bandwidth used in data parallel deep learning settings for distributing gradient updates in parameter server based settings as well as peer-to-peer (P2P) settings. A first advantage of the embodiments is significantly compressing traffic for networks trained with dropout in parallel deep learning Big Data settings where datacenter/cluster capacity is saturated. A second advantage of the embodiments is compatibility with P2P and parameter server architectures. Assuming bandwidth saturation, embodiments of the invention can be used to train big data enabled networks faster.

Training neural networks is based on minimizing a loss function and adjusting the neural network's weights. In deep learning settings, the updates should be applied correctly across the different network layers. A particular class of approaches to training neural networks relies on using continuous, differentiable loss functions (e.g. the mean squared error, Equation (1)) and continuous, differentiable network activation functions (e.g. the sigmoid function Equation (2)).

$$\begin{matrix}L = \frac{1}{N} {\sum }_{i = 1}^{N} {( {t}_{i} - f ( {x}_{i} ) )}^{2} & ( 1 ) \\ \frac{1}{1 + {e}^{- x}} & ( 2 )\end{matrix}$$

In Equation (1), N is the number of samples, tᵢ is the i^{th} target value, f (xᵢ) is the neural network prediction for input sample xᵢ. For the simple iterative gradient descent based backpropagation, the neural network updates it's different layers' weights wⱼ by calculating and applying the appropriate partial error derivatives

$$\frac{\partial L}{\partial {w}_{j}}$$

(for simplicity of notation, here only a single index j is used). Using a vector notation, the layer-wise propagated gradient of L is denoted ∇L. Then, the weights of layer l are updated by the layer-wise propagated gradient as Equation (3) with a being a learning rate parameter.

\vec{Wₗ}=\vec{Wₗ}−a∇Lₗ (3)

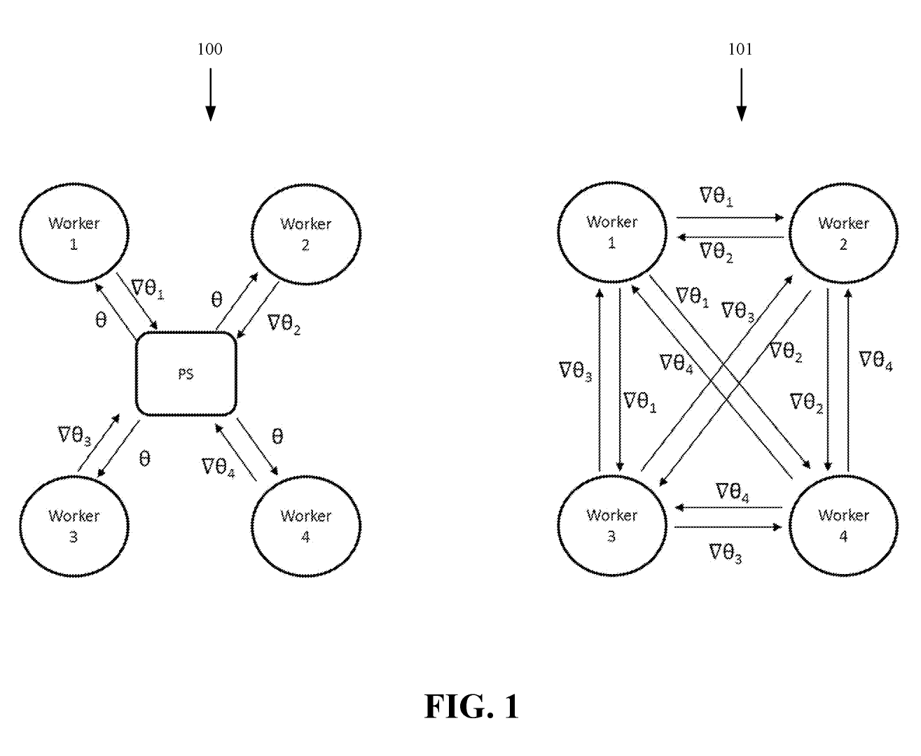

There are two forms of parallelism for deep learning: (1) model parallelism and (2) data parallelism. J. Dean et al., “Large Scale Distributed Deep Networks” NIPS (2012), which is incorporated by reference in its entirety, discusses the two forms of parallelism. FIG. 1 illustrates data parallelism models in a parameter server setting 100 vs a P2P setting 101 according to an embodiment of the invention. In FIG. 1, each worker is a computing device, e.g., a server or computer with one or more processors and one or more computer-readable media for execution of instructions present on the one or more non-transitory computer-readable media. The one or more processors in each worker may be a central processing unit (CPU), GPU, or a combination of both. Each worker also includes one or more network interfaces for sending and receiving information. In the parameter server setting 100, PS designates a parameter server which includes components similar to that of the worker.

Model parallelism is seldom required, as modern computing resources should probably be able to handle large model instances within a single machine. More prominent is data parallelism, i.e., a set of worker nodes train model replicas on partitions of the input data in parallel. As each worker sees a different partition, it will compute gradients different from the other workers. To achieve a model convergence on the entire data set, there exist two main paradigms:
a. Workers synchronize gradients via parameter servers, as e.g. in J. Dean et al.: The parameter servers apply the gradients to the overall model and distribute updated model replicas to the workers. It is possible to have multiple parallel parameter servers, each responsible only for a distinct sub-part of the model.
b. Workers can also exchange gradients in a P2P fashion—each worker aggregates other workers' gradients with its own and updates its local model replica. H. Li et al., “MALT: Distributed Data-Parallelism for Existing ML Applications,” European Conference on Computer Systems (2015) and P. Watcharapichat, “Ako: Decentralized Deep Learning with Partial Gradient Exchange” ACM Symposium on Cloud Computing (2016), which are hereby incorporated by reference in their entireties, provide background on P2P gradient synchronization.
c. Among other optimizations, H. Zhang et al., develops a hybrid communication scheme that can choose between P2P and parameter server based synchronizations, depending on the type of NN layer whose gradients are to be exchanged.

Another dimension is the level of synchronicity: it is not necessary to completely synchronize and update the workers' gradients—a certain amount of staleness is permissible while still guaranteeing model convergence.

Moreover, gradient matrix updates exchanged by Sufficient Factor Broadcasting (SFB) can be compressed. The gradient update matrix pertaining to a single training example is rank 1. This can be decomposed into two vectors (the SFBs). This compresses a N x M matrix into two vectors u and v (of size N and M) (at the cost of decomposing and reconstructing the Matrix at sender and receiver side): ΔWᵢ=u v^{T}. For certain NN layer types, this can be advantageous in the case where data center bandwidth is an issue. It is still easily possible to saturate datacenter/cluster bandwidth, thus throttling GPU computing resources for training. For mini-batch based training with SFB, see P. Xie et al., “Distributed Machine Learning via Sufficient Factor Broadcasting,” arXiv:1409.5705v2 (2015), which is incorporated by reference in its entirety. A. Vishnu et al., “Distributed TensorFlow with MPI,” arXiv:1603.02339v2 (2017), which is incorporated by reference in its entirety, describes integration of openMPl with TensorFlow and can be used to enable efficient P2P broadcasting of parameters.

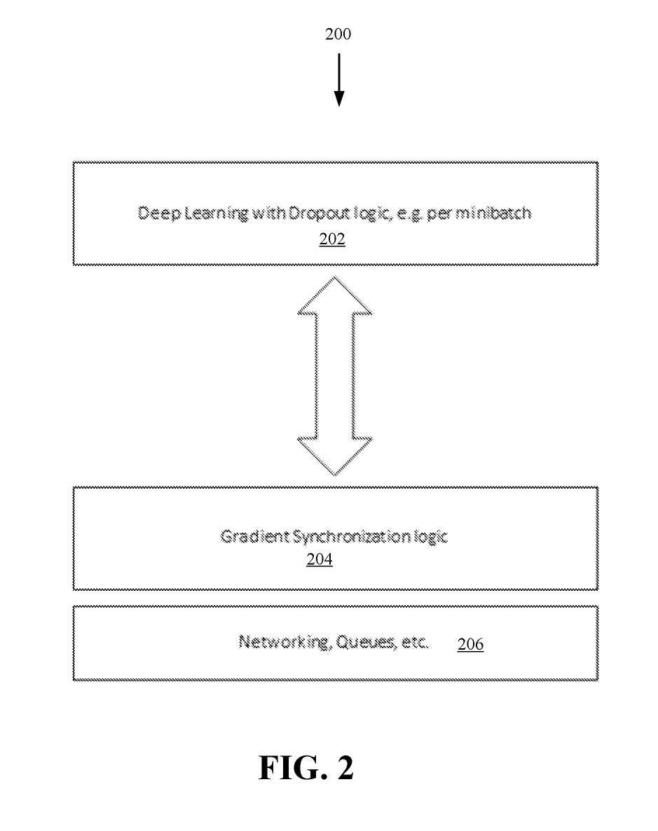

FIG. 2 illustrates an idealized deep learning node 200 according to an embodiment of the invention. The deep learning component 202 applies a specified deep learning model on the slice of data to which the worker is assigned. This creates gradients for the mini-batch/sample that the worker needs to synchronize according to a defined Gradient Synchronization Logic 204 (e.g. P2P). Here, possibly the gradient matrix ΔW is decomposed into sufficient factor vectors u, v. The gradients are distributed to other workers via common networking routines and other workers' gradients are received. These are integrated then in the Gradient Synchronization Logic and fed to the deep learning component 202, which updates the weights accordingly. The idealized deep learning node 200 can be a worker or a parameter server.

A popular NN training technique known to safeguard against the common problem of overfitting is dropout. In the dropout technique, a configurable fraction of neurons is randomly chosen not to activate (and their weights also do not receive gradient updates). This randomness is per sample (or per mini-batch) and applies to each dropout layer. Y. Gal et al., “Dropout as a Bayesian Approximation: Representing Model Uncertainty in Deep Learning,” International Conference on Machine Learning (2016), which is hereby incorporated by reference in its entirety, provides background on dropout. Dropout is not limited to a particular kind of layer connection structure and can be applied to fully connected and to convolutional layers. Dropout also allows the extraction of model uncertainty. In general, the dropout technique is commonly used in NN training to overcome overfitting and additionally can provide means to quantify model uncertainty, which is desirable for some applications.

Each neuron of Layer i gets activated by multiplying all the neuron's Kᵢ₋₁ input edge weights with the neuron activations of layer i−1 and summing. Thereafter, the neuron's nonlinearity g(x) is applied to the sum. To enable efficient computing, NN forward passes (i.e. predictions) are realized by matrix—vector multiplications. Denoting the weight matrix Wᵢ for layer i=1 . . . L with the dimensions Kᵢ×Kᵢ₋₁, where K denotes the number of neurons of layer i. Then, the layer i neuron activations can be represented as a vector \vec{hₗ}=g(Wᵢ^{T}\vec{hₗ₋₁}) where \vec{hₗ₋₁} denotes the vector representing the Kᵢ₋₁ neuron activations layer i−1. If l=1, the input data is used as \vec{h₀}. Note that for simplification, we did not explicit discuss the bias neuron (and its weights) that are commonly used in NN learning. While in this case the dimensionalities change, the concepts remain unchanged.

Embodiments of the invention compress gradient updates for data parallel deep models in GPU clusters among different cluster nodes. To conserve bandwidth, the embodiments use the insight that columns (or rows) set to 0 can be dropped from gradient updates that are to be synchronized/shared among workers. By recognizing that in particular dropout results in favorable 0 structures in NN weight matrices, the embodiments advocate using dropout aggressively in the parallel deep learning to help compression by the following mechanisms/procedures. Note that selecting the indices of neurons to be dropped is not limited to a particular distribution (e.g. uniform, or Gaussian).

In any learning iteration, considering that in dropout a layer's neuron is stochastically turned off completely means that its activation weights are neither propagated nor trained—when a neuron is dropped, this can be represented as setting its corresponding column in Wᵢ to 0 prior to executing Equation 3. Similarly, when back-propagating gradients in the update matrix ΔWᵢ, the column corresponding to the dropped unit is set to 0. As synchronization in data parallelism focuses on gradient updates, the insight is relevant to ΔWᵢ. When using the SFB approach, the vector's v's entry corresponding to the dropped neuron is set to 0.

ΔWᵢ entries commonly come with a particular data representation, e.g., 32-bit or 64 bit floating point precision. In an embodiment, the invention adds a compression/reconstruction unit to the parameter server and worker instances that uses the following algorithms that work on the gradient matrix or the sufficient factor vector v. These algorithms are represented in pseudo code and thus index manipulations, copy operations, and entry shifting operations are not documented. Procedures I, II and V relate to the parameter server approach. Procedures III, IV and VI relate to the SFB approach.

Procedure I:

```
def compressGradientMatrix( )
    #removes gradients associated to dropped neurons of this layer,
    provided a list of the dropped neurons indices
```

| | |
|---|---|
| Inputs: | gradientMatrix ΔW |

List of indices of neurons dropped indexList

| | |
|---|---|
| Returns: | compressed gradientMatrix ΔWc |
| | List of indices of neurons dropped indexList |

```
    ΔWc = ΔW
    For each index in indexList:
    Remove column [index] from ΔWc
Return (ΔWc, indexList)
```

Procedure II:

```
def compressGradientMatrixFindZeros( )
    #removes gradients associated to dropped neurons of this layer, by
    identifying columns in gradient matrix all 0.
```

| | |
|---|---|
| Inputs: | gradientMatrix ΔW |
| Returns: | compressed gradientMatrix ΔWc |
| | List of indices of neurons dropped indexList |

```
    ΔWc = ΔW
    indexList = { }
    For each columIndex in columns of ΔWc
        If sum(abs(ΔWc[columnIndex])) == 0
```

Remove column [columIndex] from ΔWc
indexList.append(columnIndex)

Return (ΔWc, indexList)

Procedure III:

| def compressGradientSF( ) | |
|---|---|
| #removes gradients associated to dropped neurons of this layer | |
| Inputs: | gradientSF v |
| List of indices of neurons dropped indexList | |
| Returns: | compressed gradientSF vc |
| | List of indices of neurons dropped indexList |

```
    vc = v
    For each index in indexList
        Remove entry index in vc
Return (vc, indexList)
```

Procedure IV:

| def compressGradientSFFindZeros( ) | |
|---|---|
| #removes gradients associated to dropped neurons of this layer | |
| Inputs: | gradientSF v |
| Returns: | compressed gradientSF vc |
| | List of indices of neurons dropped indexList |

```
    vc = v
    indexList = { }
    For each index in 1..length of v
        If v[index]==0 remove entry from vc
        indexList.append(index)
Return (vc, indexList)
```

compressGradientSF ( ) and compressGradientSFFindZeros ( ) can both be applied to compress vector u (if that is desirable). compressGradientMatrix ( ) and compressGradientMatrixFindZeros ( ) can be extended to compress out zero rows of the gradient matrix. Further, given a gradient matrix, a function that compresses out dropped neurons' weights, then derives sufficient factors u and vc can be constructed as well. Same holds for the following decompression counterpart algorithms.

Procedure V:

```
def decompressGradientMatrix( )
    #adds gradients (0 values) associated to dropped neurons of this layer,
    provided a list of the dropped neurons indices
```

| | |
|---|---|
| Inputs: | compressed gradientMatrix ΔWc |

List of indices of neurons dropped indexList

| | |
|---|---|
| Returns: | original gradientMatrix ΔW |

```
    ΔW = ΔWc
    For each index in indexList:
        Insert column [index]: zeroes(ΔW.rows( ))
    Return ΔW
```

Procedure VI:

```
def decompressGradientSF( )
    # adds gradients (0 values) gradients associated to dropped neurons of
    this layer
```

| | |
|---|---|
| Inputs: | compressed gradientSF vc |

List of indices of neurons dropped indexList

| | |
|---|---|
| Returns: | original gradientSF v |
| | List of indices of neurons dropped indexList |

```
    vc = v
    For each index in indexList
        Insert 0 into vc[index]
Return v
```

While the compressed gradient matrix/sufficient factor vector have been reduced in size, the list of dropped neurons is transmitted along with the compressed matrix. This can be either done as an explicit list of integers, or e.g., as a Boolean or TRUE/FALSE vector (length of neurons of the corresponding layer). The TRUE/FALSE vector can then be further compressed, e.g., by run-length compression or similar schemes.

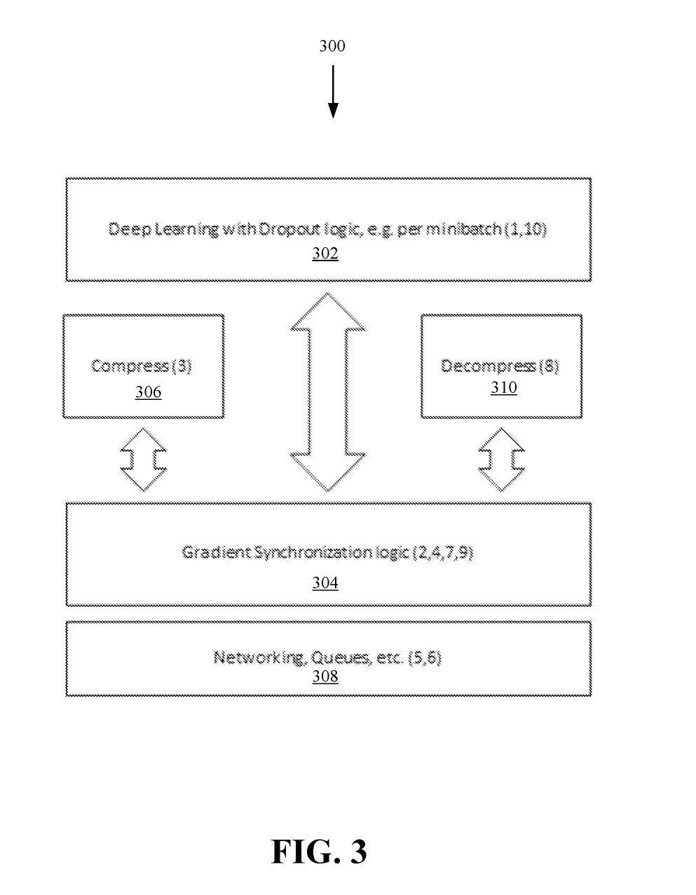

FIG. 3 illustrates a zero injection deep learning node 300 according to an embodiment of the invention. FIG. 3 illustrates a deep learning worker compatible with the architectures in FIG. 1. FIG. 3 is based on the idealized node in FIG. 2, but adds gradient compression 306 and decompression 310 logic components. These components run the compression/decompression algorithms given above in Procedures I-VI.

In an embodiment directed at a P2P setting, when the deep learning component 302 of the node 300 generates a new gradient update matrix (1) to be synchronized with other nodes, the gradient synchronization logic 304 provides the gradients or the sufficient factors to the compression component 306 (possibly along with the dropout information) (2). The compression logic component 306 removes 0's from the gradient matrix (3). The gradient synchronization logic 304 receives back a compressed AWc or vc and dropped neuron information indexList (4). The gradient synchronization logic 304 sends the compressed gradients (either ΔWc or (u,vc)) and the dropped neuron information indexList to other workers for synchronization (5). Upon receiving other workers' compressed ΔWc or (u,vc) and dropped neuron information indexList (6), the gradient synchronization logic 304 passes the information to the decompression component 310 (7,8). Receiving back a decompressed gradient matrix (8,9), the gradient synchronization logic 304 then merges the nodes' 300 local as well as the other workers' decompressed gradients (9). These are then sent to the deep learning component 302 for further training (10).

In a general deployment, or when training some layers without dropout, received gradient matrices or SFBs might not always be compressed. Hence, the gradient synchronization logic 304 may check received weight matrices from other workers for compression and when not compressed, directly forward the matrices to the deep learning component 302, bypassing the decompress component 310.

In an embodiment directed at a parameter server setting, when the worker node 300 generates a new gradient update matrix (1) to be synchronized with other nodes via the parameter server, the gradient synchronization logic 304 provides the gradients or the sufficient factors to the compression component 306 (possibly along with the dropout information) (2). The compression logic component 306 removes 0's from the gradient matrix to compress the gradient matrix (3). The gradient synchronization logic 304 receives back a compressed ΔWc or vc and dropped neuron information indexList (4). The gradient synchronization logic 304 sends the compressed gradients (either ΔWc or (u,vc)) and the dropped neuron information to the parameter server for synchronization (5).

In a first embodiment, upon receiving the parameter server gradient matrix from the network 308 (6,7), the gradient synchronization logic 304 determines if the received information is a compressed gradient matrix. If it is not, the parameter server gradient matrix is passed directly to the deep learning component 302 for further training (10). If the parameter server gradient matrix is compressed, the gradient synchronization logic 304 passes the compressed information to the decompression component 310 for decompression (7,8). Receiving back the decompressed gradient matrix (9), the gradient synchronization logic 304 passes the gradient matrix to the deep learning component 302 for further training (10).

In a second embodiment, upon receiving the parameter server's updated parameter matrix from the network 308 (6,7) the gradient synchronization logic 304 can forward it directly to deep learning component 302 for replacing the outdated parameters (10).

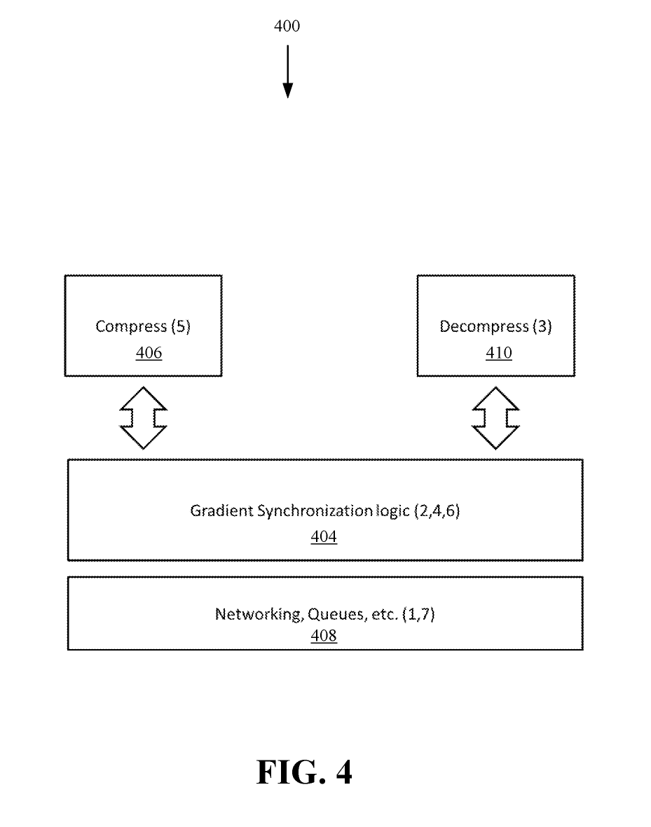

FIG. 4 illustrates a parameter server 400 supporting zero injection according to an embodiment of the invention. Upon receiving the compressed gradient matrices or SFB from the different workers via the network 408 (1), the gradient synchronization logic 404 (2) forwards it to the decompression logic 410 (3) and receives back decompressed gradient matrices. The gradient synchronization logic 404 merges these decompressed gradient matrices, and in the process may choose to compress these matrices using the compression component 406 (5). The gradient synchronization logic 404 then forwards, via the network 408, to all workers (6,7). In case the received matrices or SFBs are uncompressed (e.g. if some layers are trained without dropout), the decompression (3) is bypassed. In some embodiments, compressing gradient matrices is feasible if the workers random number generators are synchronized for the dropout operation. In other embodiments, the gradient synchronization logic 404 bypasses compression at step (5) and sends uncompressed gradient matrices to the workers through network 408.

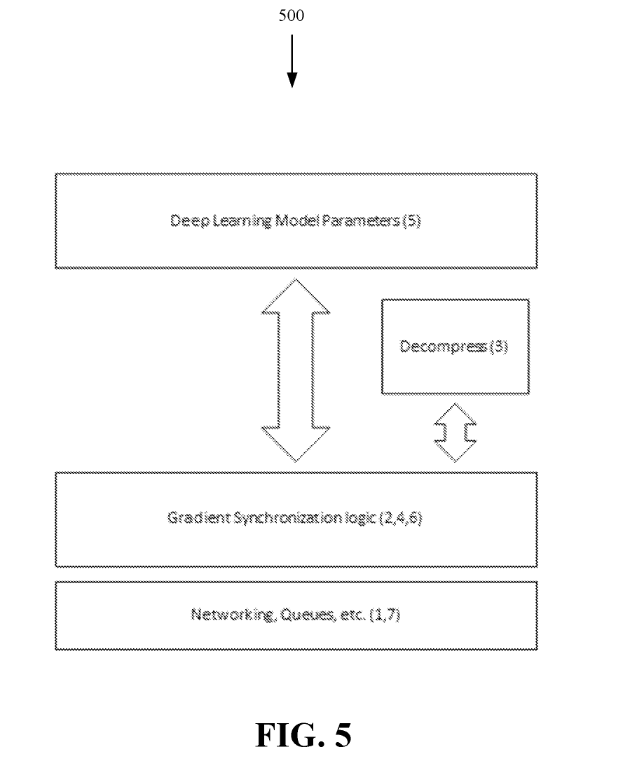

FIG. 5 illustrates a parameter server 500 supporting zero injection according to an embodiment of the invention. The parameter server 500 merges the (decompressed) gradient updates and applies these to the general model parameters (5). The updated general model parameters are then sent out to all worker nodes (7).

Tables I and II show exemplary saving calculations when applying embodiments of the invention.

TABLE I
Exemplary saving calculations per fully connected layer gradient Matrix of N × M

| | 5% dropout | 10% dropout |
|---|---|---|
| 32 bit float, Indexlist of Integer | 0.05 × N × M × 4 − 0.05 × N × 2 bytes | 0.1 × N × M × 4 − 0.1 × N × 2 bytes |
| (16 bit) | | |
| 64 bit float, Indexlist of Integer | 0.05 × N × M × 8 − 0.05 × N × 2 bytes | 0.1 × N × M × 8 − 0.1 × N × 2 bytes |
| (16 bit) | | |
| 32 bit float, bitvector index | 0.05 × N × M × 4 − N/8 bytes | 0.1 × N × M × 4 − N/8 bytes |
| 64 bit float, bitvector index | 0.05 × N × M × 8 − N/8 bytes | 0.1 × N × M × 8 − N/8 bytes |
| 32 bit float, bitvector index, run- | 0.05 × N × M × 4 − (2 × 0.05 × N + 1) × 2 bytes | 0.1 × N × M × 4 − (2 × 0.1 × N + 1) × 2 bytes |
| length compression (16 bit | 0.05 × N × M × 4 − 2 × 2 bytes | 0.1 × N × M × 4 − 2 × 2 bytes |
| integers) [worst case; best | | |
| case] | | |
| 64 bit float, bitvector index, run- | 0.05 × N × M × 8 − (2 × 0.05 × N + 1) × 2 bytes | 0.1 × N × M × 8 − (2 × 0.1 × N + 1) × 2 bytes |
| length compression (16 bit | 0.05 × N × M × 8 − 2 × 2 bytes | 0.1 × N × M × 8 − 2 × 2 bytes |
| integers), [worst case; best | | |
| case] | | |

TABLE II
Exemplary saving calculations per fully connected gradient SF v of dimensionality N

| | 5% dropout | 10% dropout |
|---|---|---|
| 32 bit float, Indexlist of Integer | 0.05 × N × 4 − 0.05 × N × 2 bytes | 0.1 × N × 4 − 0.1 × N × 2 bytes |
| (16 bit) | | |
| 64 bit float, Indexlist of Integer | 0.05 × N × 8 − 0.05 × N × 2 bytes | 0.1 × N × 8 − 0.1 × N × 2 bytes |
| (16 bit) | | |
| 32 bit float, bitvector index | 0.05 × N × 4 − N/8 bytes | 0.1 × N × 4 − N/8 bytes |
| 64 bit float, bitvector index | 0.05 × N × 8 − N/8 bytes | 0.1 × N × 8 − N/8 bytes |
| 32 bit float, bitvector index, run- | 0.05 × N × 4 − (2 × 0.05 × N + 1) × 2 bytes | 0.1 × N × 4 − (2 × 0.1 × N + 1) × 2 bytes |
| length compression (16 bit | 0.05 × N × 4 − 2 × 2 bytes | 0.1 × N × 4 − 2 × 2 bytes |
| integers) [worst case; best | | |
| case] | | |
| 64 bit float, bitvector index, run- | 0.05 × N × 8 − (2 × 0.05 × N + 1) × 2 bytes | 0.1 × N × 8 − (2 × 0.1 × N + 1) × 2 bytes |
| length compression (16 bit | 0.05 × N × 8 − 2 × 2 bytes | 0.1 × N × 8 − 2 × 2 bytes |
| integers), [worst case; best | | |
| case] | | |

The calculations in Tables I and II are conservative. Each neuron was assumed to dropout with probability of 0.5. It is understood that other probabilities may be set. Also, dropout can be applied not only to fully connected layers, but also to, e.g., convolutional layers.

In the case of P2P distribution of updates, both Tables I and II scale with the squared number of workers. In case the process shown in A. Vishnu et al. is used, compression savings are lower, since the broadcasting itself is improved (at the cost of delay introduced by MPI tree-like broadcasting).

Embodiments of the invention are relevant to parameter updates that have a common neuron dropped. This is the case for parameter server approaches where all parallel instances create the same drop-out neurons (e.g. by synching the random number generator seeds), as well as for P2P where within one layer update ΔWᵢ the same neurons are dropped (e.g. via SFB, via partial gradient sharing, or via full P2P ΔWᵢ broadcasting among workers. For parameter server based settings, where the random number generator seeds among workers are not synchronized, the compression benefits for sending update matrices from workers to parameter servers are still applicable. However, the opposite direction, i.e., from parameter servers to workers, is not compressed in the general setting. However, in an embodiment the workers' random number generators are orchestrated such that all workers draw the same neurons to be dropped and the neurons are dropped for the entire mini-batch as mentioned above in relation to the parameter server 400. Then, the parameter server 400 can merge the different workers' gradients updates into a single gradient matrix and distribute that (instead of the updated weight matrix Wᵢ) in compressed (via above methods) form to all workers. The workers then decompress the merged gradient matrix received from the parameter server 400 via the described decompression logic, and then apply it to their individual copy of the weight matrix Wᵢ.

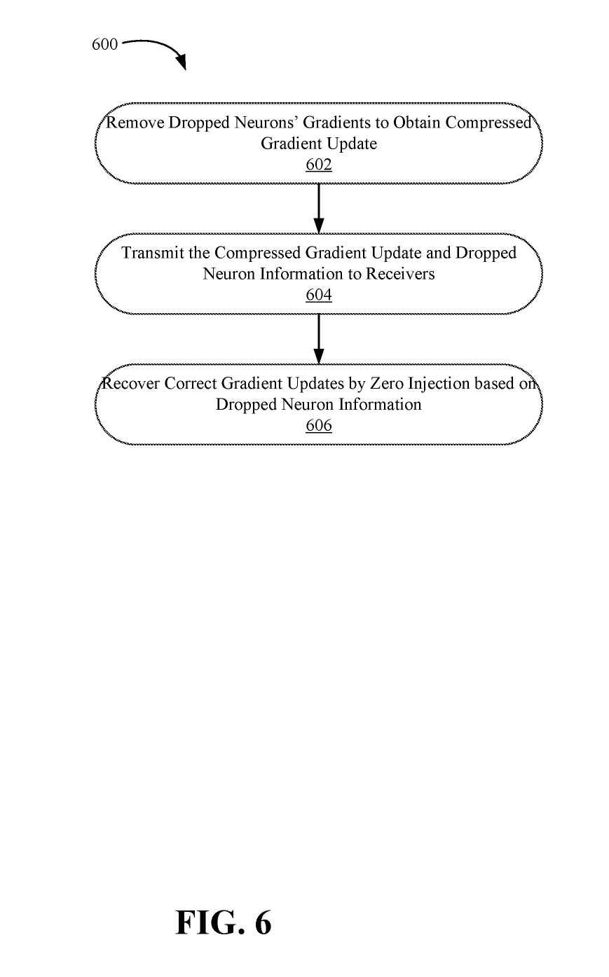

FIG. 6 is a flowchart for compressing distributed deep learning gradient traffic in data parallel settings according to an embodiment of the invention. FIG. 6 formalizes steps already provided in the different embodiments of FIGS. 3-5. At step 602, a worker removes gradients of dropped neurons from gradient updates in order to obtain a compressed gradient update. In any learning iteration using dropout, the worker determines which neurons are dropped and updates a gradient matrix Wᵢ or in the case of SFB, updates a vector v by setting entries corresponding to the dropped neurons to 0. The indices of the dropped neurons are generated, while entries in the gradient matrix Wᵢ or the SF vector v are removed.

At step 604, the worker transmits the compressed gradient update (gradient matrix with removed entries) and dropped neuron information (the indices) to receivers. Receivers may be other workers or a parameter server as shown in the two architectures of FIG. 1. The receivers then use the received compressed gradient update and the dropped neuron information to reconcile neural network weight updates.

At step 606, the worker recovers correct gradient updates by zero injection into compressed gradient updates received from other workers, based on the dropped neuron information. Just as the specific worker provides gradient weight updates to receivers (other workers or a parameter server), the specific worker receives gradient weight updates from the receivers. In a P2P setting, each worker reconciles received gradient weight updates after zero injection.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for compressing distributed deep learning gradient traffic in data parallel settings, the method comprising:
removing gradients of dropped neurons from gradient updates to obtain a compressed gradient update;
transmitting dropped neuron information and the compressed gradient update to one or more receivers; and
recovering correct gradient updates by zero injection into the compressed gradient update based on the dropped neuron information.

2. The method according to claim 1, wherein the one or more receivers comprise a parameter server or a worker node.

3. The method according to claim 1, wherein the dropped neuron information comprises an explicit list of integers or a Boolean vector.

4. The method according to claim 1, wherein gradient updates are in a matrix data structure or a sufficient factor vector data structure.

5. The method according to claim 1, wherein one worker node in a group of worker nodes configured in a peer-to-peer setting performs the removing, transmitting, and recovering steps.

6. The method according to claim 5, further comprising:
receiving, by the one worker node from the group of worker nodes, one or more compressed gradient matrices;
decompressing the one or more compressed gradient matrices to obtain one or more decompressed gradient matrices; and
merging the one or more decompressed gradient matrices with the gradient updates.

7. A system for data parallelism, comprising:
a parameter server; and
one or more worker nodes, each worker node being configured to:
remove gradients of dropped neurons from gradient updates to obtain a compressed gradient update;
transmit dropped neuron information and the compressed gradient update to the parameter server;
wherein the parameter server is configured to:
receive compressed gradient updates from each of the one or more worker nodes;
decompress the compressed gradient updates to obtain one or more decompressed gradient updates based on the dropped neuron information;
merge the one or more decompressed gradient updates to obtain a merged gradient update.

8. The system according to claim 7, wherein the parameter server is further configured to:
compress the merged gradient update; and
transmit the compressed merged gradient update to the one or more worker nodes.

9. The system according to claim 7, wherein the parameter server is further configured to:
transmit the merged gradient update to the one or more worker nodes.

10. A worker node for data parallelism, the worker node having one or more processors which, alone or in combination are configured to provide for performance of the following steps:
removing gradients of dropped neurons from gradient updates to obtain a compressed gradient update;
transmitting dropped neuron information and the compressed gradient update to one or more receivers; and
recovering correct gradient updates by zero injection into the compressed gradient update based on the dropped neuron information.

11. The worker node according to claim 10, wherein the one or more receivers comprise a parameter server or a worker node.

12. The worker node according to claim 10, wherein the dropped neuron information comprises an explicit list of integers or a Boolean vector.

13. The worker node according to claim 10, wherein gradient updates are in a matrix data structure or a sufficient factor vector data structure.

14. The worker node according to claim 10, wherein the one or more processors are configured to provide for the performance of:
receiving a second correct gradient update from a parameter server, wherein zero injection was performed on the second correct gradient update; and
updating a local model replica with the second correct gradient update.

15. The worker node according to claim 10, wherein the one or more processors are configured to provide for the performance of:
receiving a second compressed gradient update and a second dropped neuron information from another worker node;
recovering a second correct gradient update by zero injection into the second compressed gradient update based on the second dropped neuron information; and
updating a local model replica with the second correct gradient update.
